(19) United States
(12) Patent Application Publication
(10) Pub. No.: US 2016/0292733 A1
(43) Pub. Date: Oct. 6, 2016

(54) OPTIMIZING ONLINE TRAFFIC ALLOCATION BETWEEN CONTENT SOURCES

(71) Applicants: Chitta Ranjan, Atlanta, GA (US); Huma Zaidi, So San Francisco, CA (US)

(72) Inventors: Chitta Ranjan, Atlanta, GA (US); Huma Zaidi, So San Francisco, CA (US)

(21) Appl. No.: 14/673,655

(22) Filed: Mar. 30, 2015

(51) Int. Cl. G06Q 30/02

(52) U.S. Cl. CPC G06Q 30/0256

(57) ABSTRACT

A system and method for optimizing online traffic allocation between content sources are provided. In example embodiments, assigning a query score for each of a set of advertisement sources, accessing historical data from a database, determining a threshold value based on historical data of traffic share allocation between at least two advertisement sources satisfying a predefined criteria, selecting an advertisement source from the set of advertisement sources based on the query score for the advertisement source exceeding the threshold value, and selecting an advertisement source based on the query score exceeding the threshold value.

### TECHNICAL FIELD

Embodiments of the present disclosure relate generally to the technical field of online traffic allocation, and, more particularly, but not by way of limitation, to optimizing online traffic allocation between content sources when optimizing for multiple objectives.

### BACKGROUND

The display of content based on a query suffers from a lack of optimization when there are more than one content sources, which often results in a non-compatible content source being used for a given query. While efforts are currently allocated to determining relevant content within a single content source to serve a search query, optimal assignment for source allocation between multiple content sources is lacking.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 illustrates a block diagram showing components provided within the system of FIG. 1, according to some example embodiments.

FIG. 3 is a block diagram illustrating an example embodiment of an advertisement source regulation system, according to some example embodiments.

FIG. 4 is a block diagram illustrating an example method for advertisement source management, according to some example embodiments.

FIG. 5 is a graph illustrating an example method for determining a threshold parameter for different objectives, according to some example embodiments.

FIG. 6 is a graph illustrating an example of polynomial model fitting to data for computing a threshold, according to some example embodiments.

FIG. 7 is a flow diagram illustrating an example of polynomial model fitting to data for computing a threshold, according to some example embodiments.

FIG. 8 is a graph illustrating an example of polynomial model fitting to data for computing a threshold, according to some example embodiments.

FIG. 9 is a graph illustrating an example of weighted data points of the polynomial model, according to some example embodiments.

FIG. 10 is a flow diagram illustrating an example method for advertisement sourcemanagement, according to some example embodiments.

FIG. 11 is a flow diagram illustrating example operations for allocating traffic shares for the purpose of knowledge discovery objective, according to some example embodiments.

FIG. 12A is a graph illustrating an example of multi-dimensional model fitting for maximizing multiple performance metrics, according to some example embodiments.

FIG. 12B is a graph illustrating an example of multi-dimensional model fitting in the presence of three ad sources, according to some example embodiments.

FIG. 13 is a flow diagram illustrating an example method for determining the advertisement source to assign to serve a query in the presence of multiple ad sources, according to some example embodiments.

FIG. 14 is a block diagram illustrating an example of a software architecture that may be installed on a machine, according to some example embodiments.

FIG. 15 is a block diagram presenting a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Over the last decade, internet advertising has witnessed substantial growth with consistent increase in year-over-year revenue growth. The advertisement growth trend is expected to increase at a similar rapid pace in the coming years and therefore there is a need to better serve this growth where internet advertisement is prevalent and the number of advertisement source (hereafter ad source) increases to meet the demand.

Search advertisements are advertisements that are displayed based on query content. Currently, optimization techniques are not used when there is more than one advertisement (ad) source for serving the search advertisements. Optimization is especially important in instances where companies are also advertisement publishers comprising both external and the company's own advertisement inventories (in-house inventories). In such instances, the ad publishers have more than one ad source for serving search ads and therefore would benefit from a model to optimize the allocation of the search ad traffic to a specific ad source in order to maximize revenue or maximize traffic share for the in-house source. An ad publisher that allocates impressions to the best source for that corresponding query can potentially result in higher clicks for the advertisements and as a result higher revenues. As an example, one ad source performs better for the women clothing category, while other ad sources perform better for the sports category because ads from its respective ad source results in a larger number of clicks or revenue.

Choosing ads from an ad source more capable of serving the query from a pool of several ad sources increases the chance of a click and revenue. Moreover, if an in-house ad inventory source is competing with an external ad source where both sources have similar capabilities in serving the query, a priority given to the in-house ad source can result in more clicks, views, and thus revenue for the desired ad source. Therefore, a content source regulation system can be used in choosing an ad source among a pool of many ad sources to serve a user query. The chosen ad choice depends on the objective of the content source regulation system, which can include maximizing revenue, maximizing the traffic share for a desired ad source with an acceptable loss of revenue, or a combination of both objectives. In various embodiments, the objective of the content source regulation system is knowledge discovery, where the system allocates a portion of the traffic share to an ad source with little or no data readily available with regards to the revenue generation associated with that specific ad source.

The features of the present disclosure provide a technical solution to the technical problem of optimizing online traffic allocation between content sources. The content source regulation system provides, in some embodiment, the technical benefit of determining an ad source in the presence of multiple ad sources to serve a query in light of the purpose of maximizing a number of objectives. As a result, the content source regulation system provides the benefit of automatically choosing the desired ad source among many ad sources to better the input query. Additionally, other technical effects will be apparent from this disclosure as well.

Although example embodiments disclosed herein refer to ads and ad sources, it is contemplated that other content and other content sources are also within the scope of the present disclosure. Accordingly, the features of the present disclosure can also be applied to content other than ads and to content sources other than ad sources.

The term, referred to hereinafter, “revenue per mille (RMP)” is known in the art and intended to include the revenue per 1,000 ad impressions. Ad publishers use RPM as a unit of measurement to determine how effective ads are at generating revenue. The term “impressions” indicates the number of times an ad is viewed or displayed on a website.

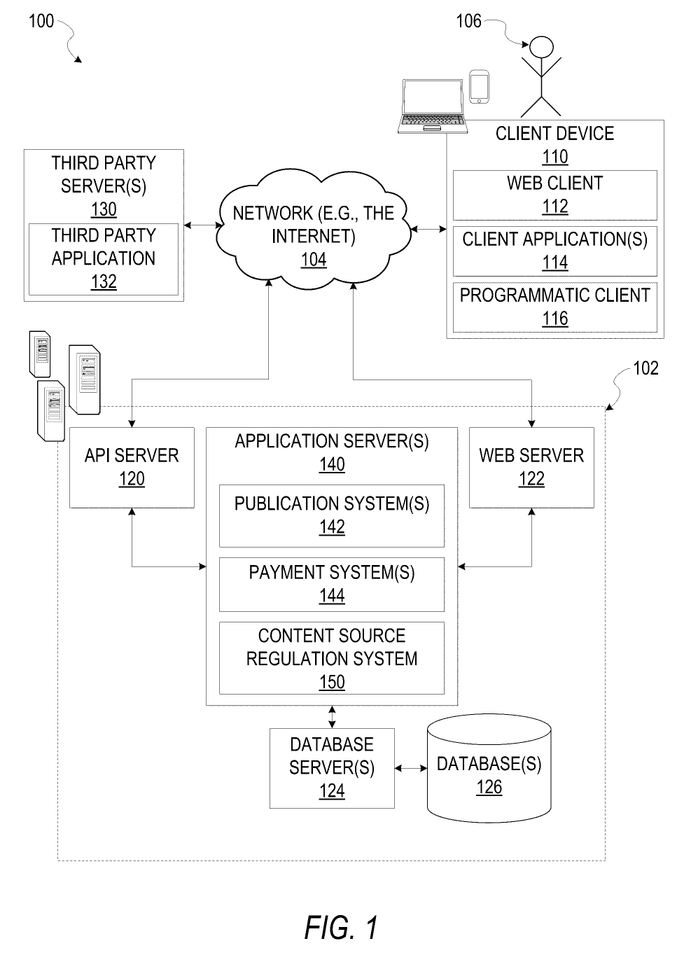

With reference to FIG. 1, an example embodiment of a high-level client-server-based network architecture 100 is shown. A networked system 102 provides server-side functionality via a network 104 (e.g., the Internet or wide area network (WAN)) to a client device 110. In some implementations, a user (e.g., user 106) interacts with the networked system 102 using the client device 110. FIG. 1 illustrates, for example, a web client 112 (e.g., a browser, such as the INTERNET EXPLORER® browser developed by MICROSOFT® Corporation of Redmond, Wash. State), client application(s) 114, and a programmatic client 116 executing on the client device 110. The client device 110 includes the web client 112, the client application(s) 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®)) network, a Worldwide Interoperability for Microwave Access (WiMax) network, another type of network, or any suitable combination thereof.

In some example embodiments, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and e-commerce site apps (also referred to as “marketplace apps”). In some implementations, the client application(s) 114 include various components operable to present information to the user and communicate with networked system 102. In some embodiments, if the e-commerce site application is included in the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120. The programmatic client 116 can, for example, be a seller application (e.g., the Turbo Lister application developed by EBAY® Inc., of San Jose, Calif.) to enable sellers to author and manage listings on the networked system 102 in an off-line manner, and to perform batch-mode communications between the programmatic client 116 and the networked system 102.

Users (e.g., the user 106) comprise a person, a machine, or other means of interacting with the client device 110. In some example embodiments, the user is not part of the network architecture 100, but interacts with the network architecture 100 via the client device 110 or another means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

The API server 120 and the web server 122 are coupled to, and provide programmatic and web interfaces respectively to, one or more application server(s) 140. The application server(s) 140 can host one or more publication system(s) 142, payment system(s) 144, and a content source regulation system 150, each of which comprises one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 also stores digital good information in accordance with some example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system(s) 142 provides a number of publication functions and services to the users that access the networked system 102. The payment system(s) 144 likewise provides a number of functions to perform or facilitate payments and transactions. While the publication system(s) 142 and payment system(s) 144 are shown in FIG. 1 to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

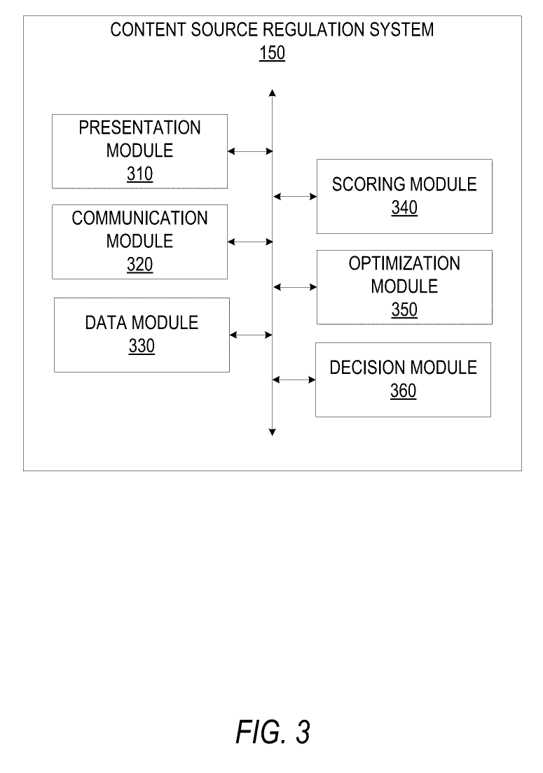

In some implementations, the content source regulation system 150 provides functionality to allocating traffic share to a specific ad source in order to optimize specific objectives, these objectives include maximizing revenue, maximizing the traffic share for a desired ad source with an acceptable loss of revenue, or a combination of both objectives. In further implementations, the content source regulation system is extended to multi-dimensional optimization, including improved traffic share assignment involving more than one performance metric and improvedal traffic share assignment in the presence of more than two ad sources. In some example embodiments, the content source regulation system 150 communicates with the client device 110, the third party server(s) 130, the publication system(s) 142 (e.g., retrieving listings), and the payment system(s) 144 (e.g., purchasing a listing). In an alternative example embodiment, the content source regulation system 150 is a part of the publication system(s) 142. The content source regulation system 150 will be discussed further in connection with FIG. 3 below.

Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the applications server(s) 140 (e.g., the publication system(s) 142 and the payment system(s) 144) can also be implemented as standalone software programs, which do not necessarily have networking capabilities.

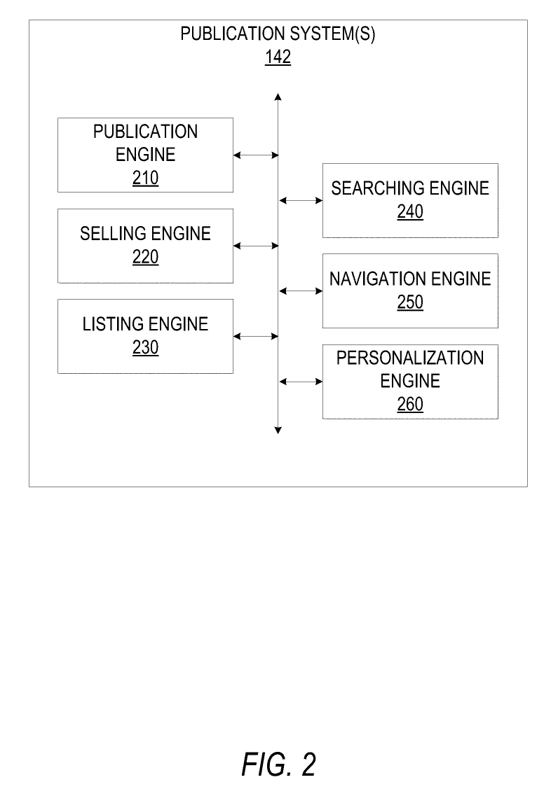

FIG. 2 illustrates a block diagram showing components provided within the publication system(s) 142, according to some embodiments. In various example embodiments, the publication system(s) 142 comprises a market place system to provide market place functionality (e.g., facilitating the purchase of items associated with item listings on an e-commerce website). The publication system(s) 142 can be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124.

The publication system(s) 142 provides a number of publishing, listing, and price-setting mechanisms whereby a seller (also referred to as a “first user”) may list (or publish information concerning) goods or services for sale or barter, a buyer (also referred to as a “second user”) can express interest in or indicate a desire to purchase or barter such goods or services, and a transaction (such as a trade) may be completed pertaining to the goods or services. To this end, the publication system(s) 142 comprises a publication engine 210 and a selling engine 220, according to some embodiments. The publication engine 210 publishes information, such as item listings or product description pages, on the publication system(s) 142. In some embodiments, the selling engine 220 comprises one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines can also provide a number of features in support of these auction-format listings, such as a reserve price feature whereby a seller specifies a reserve price in connection with a listing and a proxy-bidding feature whereby a bidder may invoke automated proxy bidding. The selling engine 220 can further comprise one or more deal engines that support merchant-generated offers for products and services.

A listing engine 230 allows sellers to conveniently author listings of items or authors to author publications. In one embodiment, the listings pertain to goods or services that a user (e.g., a seller) wishes to transact via the networked system 102. In some embodiments, the listings can be an offer, deal, coupon, or discount for the good or service. Each good or service is associated with a particular category. The listing engine 230 receives listing data such as title, description, and aspect name/value pairs. Furthermore, each listing for a good or service can be assigned an item identifier. In other embodiments, a user may create a listing that is an advertisement or other form of information publication. The listing information may then be stored to one or more storage devices coupled to the networked system 102 (e.g., database(s) 126). Listings also can comprise product description pages that display a product and information (e.g., product title, specifications, and reviews) associated with the product. In some embodiments, the product description page includes an aggregation of item listings that correspond to the product described on the product description page.

The listing engine 230 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 230 receives as much or as little listing data, such as title, description, and aspect name/value pairs, that the buyer is aware of about the requested item. In some embodiments, the listing engine 230 parses the buyer's submitted item information and completes incomplete portions of the listing. For example, if the buyer provides a brief description of a requested item, the listing engine 230 parses the description, extracts key terms, and uses those terms to make a determination of the identity of the item. Using the determined item identity, the listing engine 230 retrieves additional item details for inclusion in the buyer item request. In some embodiments, the listing engine 230 assigns an item identifier to each listing for a good or service.

In some embodiments, the listing engine 230 allows sellers to generate offers for discounts on products or services. The listing engine 230 can receive listing data, such as the product or service being offered, a price or discount for the product or service, a time period for which the offer is valid, and so forth. In some embodiments, the listing engine 230 permits sellers to generate offers from sellers' mobile devices. The generated offers can be uploaded to the networked system 102 for storage and tracking

Searching the publication system(s) 142 is facilitated by a searching engine 240. For example, the searching engine 240 enables keyword queries of listings published via the publication system(s) 142. In example embodiments, the searching engine 240 receives the keyword queries from a device (e.g., client device 110) of a user (e.g., user 106) and conducts a review of the storage device storing the listing information. The review will enable compilation of a result set of listings that can be sorted and returned to the client device 110 of the user. The searching engine 240 can record the query (e.g., keywords) and any subsequent user actions and behaviors (e.g., navigations, selections, or click-throughs).

The searching engine 240 also can perform a search based on a location of the user. A user may access the searching engine 240 via a mobile device and generate a search query. Using the search query and the user's location, the searching engine 240 returns relevant search results for products, services, offers, auctions, and so forth to the user. The searching engine 240 can identify relevant search results both in list form and graphically on a map. Selection of a graphical indicator on the map can provide additional details regarding the selected search result. In some embodiments, the user specifies, as part of the search query, a radius or distance from the user's current location to limit search results.

In a further example, a navigation engine 250 allows users to navigate through various categories, catalogs, or inventory data structures according to which listings may be classified within the publication system(s) 142. For example, the navigation engine 250 allows a user to successively navigate down a category tree comprising a hierarchy of categories (e.g., the category tree structure) until a particular set of listings is reached. Various other navigation applications within the navigation engine 250 can be provided to supplement the searching and browsing applications. The navigation engine 250 can record the various user actions (e.g., clicks) performed by the user in order to navigate down the category tree.

In some embodiments, a personalization engine 260 provides functionality to personalize various aspects of user interactions with the networked system 102. For instance, the user can define, provide, or otherwise communicate personalization settings used by the personalization engine 260 to determine interactions with the publication system(s) 142. In further example embodiments, the personalization engine 260 determines personalization settings automatically and personalizes interactions based on the automatically determined settings. For example, the personalization engine 260 determines a native language of the user and automatically presents information in the native language.

FIG. 3 is a block diagram illustrating an example embodiment of a content source regulation system 150. In an example embodiment, a content source regulation system 150 includes a presentation module 310, communication module 320, data module 330, scoring module 340, optimization module 350, and decision module 360. All, or some, of the modules 310-360 of FIG. 3 communicate with each other, for example, via a network coupling, shared memory, and the like. It will be appreciated that each module can be implemented as a single module, combined into other modules, or further subdivided into multiple modules. The data module 330 stores and provides access to historical data and assigns a weight to each data point according to the age of the data (i.e., how long ago the data was gathered compared to the current day). The scoring module 340 receives a query input from a user at the user device and assigns a score to each traffic score available to serve the query. The optimization module 350 access historical data via the data module 330 and determines a threshold value between at least two ad sources. The decision module 360 then compares the query score to the threshold value and determines which ad source is assigned to serve the query. The presentation module 310 presents in real-time an ad selected from the selected ad source by the decision module 360. Other modules not pertinent to example embodiments can also be included, but are not shown.

In some implementations, the presentation module 310 provides various presentation and user interface functionality operable to interactively present (or cause presentation) and receive information from the user. For instance, the presentation module 310 can cause presentation of an advertisement on a user interface of a user device. In various implementations, the presentation module 310 presents or causes presentation of information (e.g., visually displaying information on a screen, acoustic output, haptic feedback). Interactively presenting information is intended to include the exchange of information between a particular device and the user. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 310 provides many other user interfaces to facilitate functionality described herein. Further, it will be appreciated that “presenting” as used herein is intended to include communicating information or instructions to a particular device that is operable to perform presentation based on the communicated information or instructions.

The communication module 320 provides various communications functionality and web services. For example, the communication module 320 provides network communication such as communicating with the networked system 102, the client device 110, and the third party server(s) 130. In various example embodiments, the network communication can operate over wired or wireless modalities. Web services are intended to include retrieving information from the third party server(s) 130, the database(s) 126, and the application server(s) 140. In some embodiments, the communication module 320 receives information from the client device 110 such as advertisement parameters or metrics resulting from presented advertisements (e.g., whether the user clicked on a particular advertisement, or a number of advertisement impressions a particular user or client device has viewed).

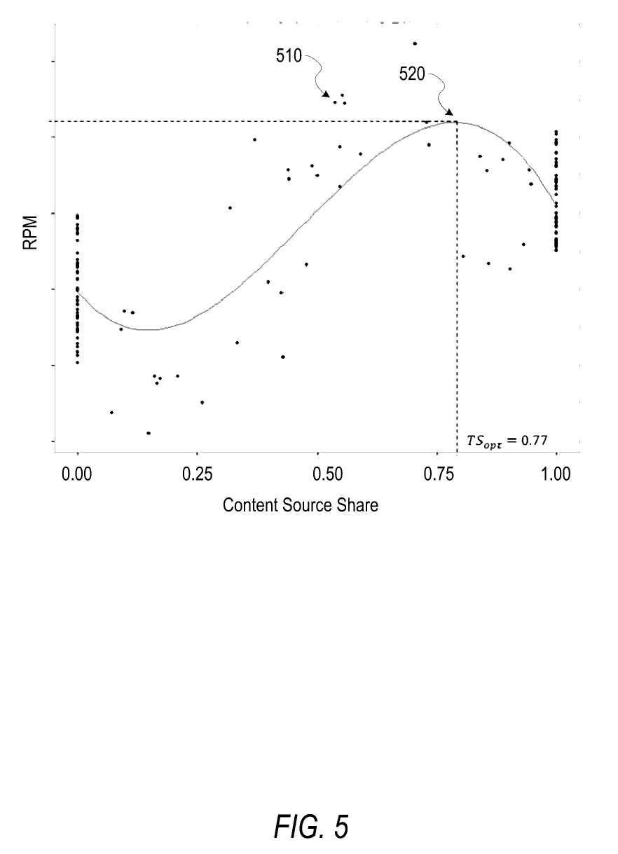

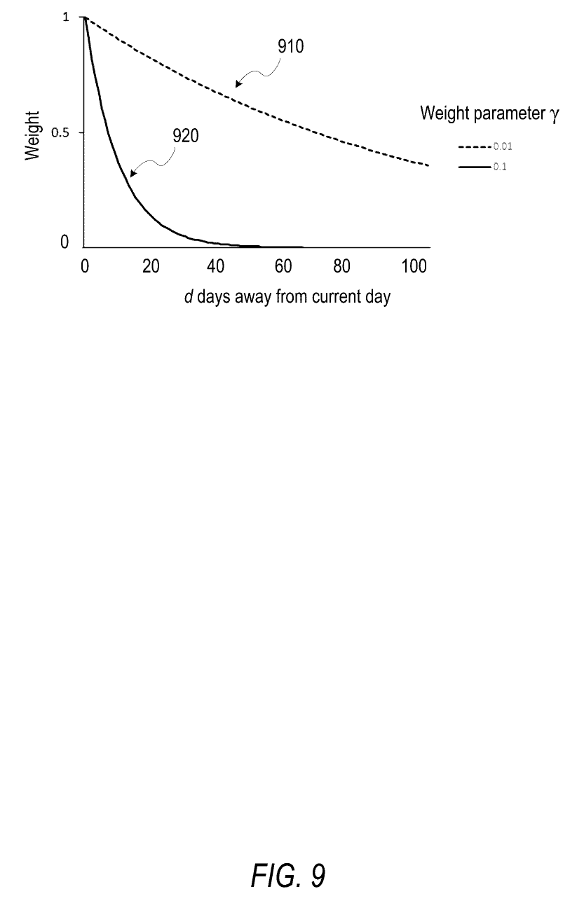

The data module 330 provides functionality to access historical data and current data, each of which include, for example, advertisement revenue, RPM, CTR (click-through rate), ad sources with corresponding RPM and CTR, score comparison rules, one or more threshold metrics from the optimization module 350, and other data. The historical data include data points of how well traffic shares from specific sources function to serve specific types of query from the user. For instance, FIG. 5-8 comprises of data points 510 and 610 that corresponds to the content share between ECN traffic share and a second ad source (e.g., google) and the resulting RPM. The data module 330 applies different weight to each data point accumulated according to how old the data point is determined to be. The weighted data points will be further discussed in connection with FIG. 9 below. In some embodiments, the historical data and the current data can be stored in the database(s) 126 and accessed by the data module 330. In various embodiments, the data module 330 stores the advertisement revenue, advertisement parameters, and cannibalization metric in the database(s) 126.

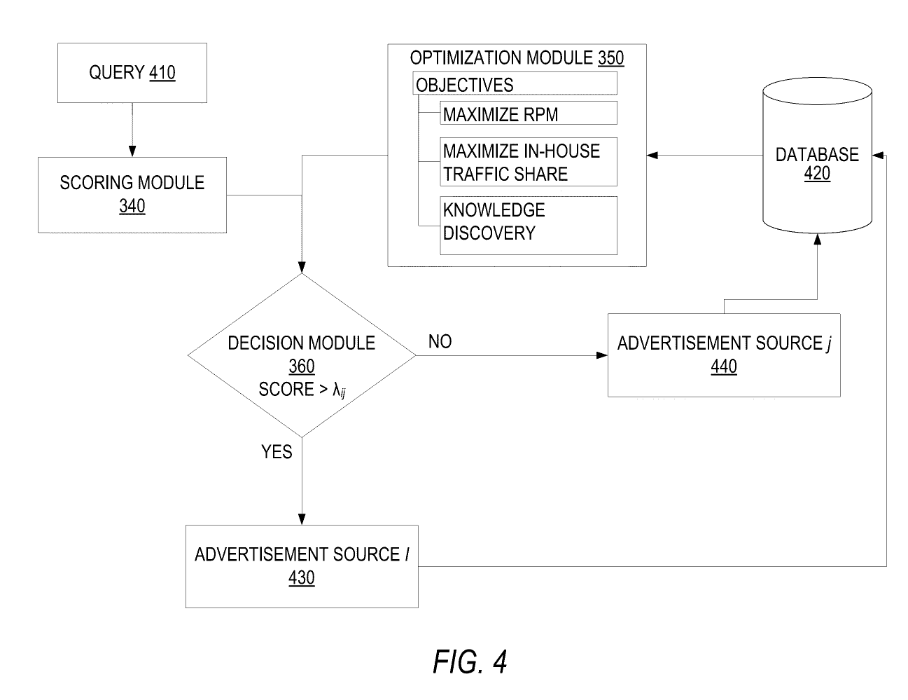

FIG. 4 is a block diagram illustrating a method for ad source management, according to some example embodiments. The scoring module 340 receives a query input 410 submitted by a user at a user interface. The scoring module 340 assigns a score for each data ad source available to serve the search query. As an example, if there are four ad sources to serve the search query, there would be four resulting query scores, one for each corresponding ad source. Each score is based on the match between the query content and ad inventory listing within each ad source. For each ad source, the scoring module 240 determines whether the advertising information stored within the ad source is relevant to the query content or the search query condition. Relevance of an ad source is based on the compared information matching in whole or at least in part. A direct relationship exist between the query score and the number of relevant ad inventory within an ad source. For instance, a higher query score indicates that the corresponding ad source contains a higher number of relevant ad inventory to serve the query. The decision module 360 uses the query score and compares it with a threshold value output, λᵢⱼ, from the optimization module 350.

In some embodiments, the optimization module 350 is configured to compute a threshold value for ad source allocation using historical data stored in a database. The threshold value differs based on the objective, which can include maximizing revenue per mile (RPM) or maximizing traffic share for a specific source, such as in-house ad source. The threshold value can be improved and optimized in light of the various objectives, individually or combine. The objective of maximizing RPM is based on determining the traffic share allocation resulting in the maximum or desired RPM. It is noted that this objective does not require an absolute maximizing of RPM, but rather reaching a predefined target RPM. In some example embodiments, different ad sources are operated, controlled, and/or owned by different entities (e.g., one ad source operated by one company and another ad source operated by another company). Two examples of ad sources serving search ads are eBay commerce network (ECN) and Google. Moreover, the threshold values for ad source allocation is periodically updated to database 420 and data module 330 for real time decision making

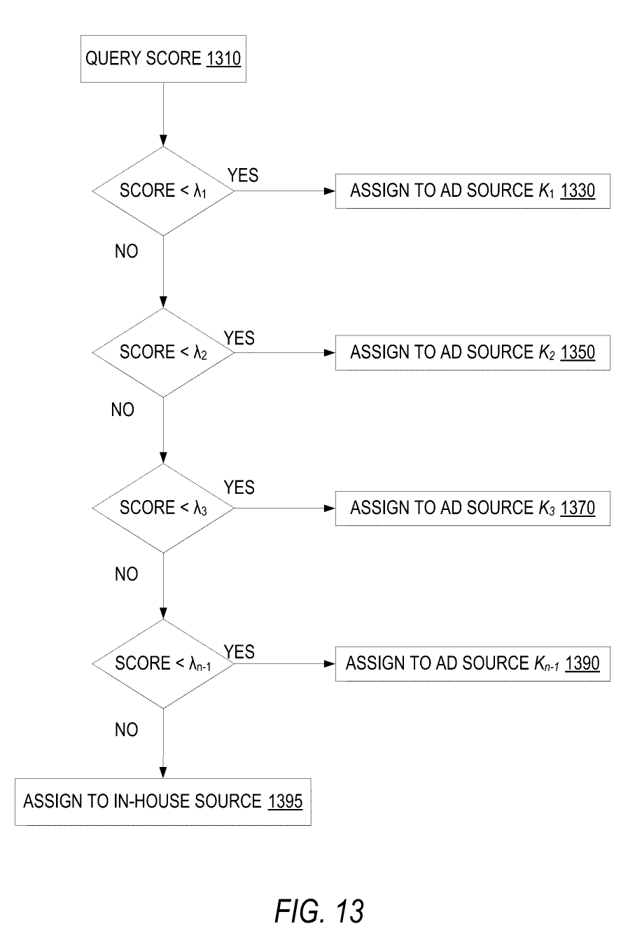

In various embodiments, the decision module 360 compares the query score determined by the scoring module 340 with the threshold value (λᵢⱼ) determined by the optimization module 350. If the query score is higher than the threshold value λᵢⱼ, ad source i 430 is chosen to serve the query because ad source i is determined to be better at serving the impression when compared to ad source j in terms of the optimization objective chosen by the optimization module 350. These objectives could include maximizing RPM, maximizing in-house traffic share, knowledge discovery, or a combination of any three of the objectives. However, if the query score if lower than the threshold value λᵢⱼ, ad source j 440 is chosen to serve the query because ad source j is determined to be better at serving the impression when compared to ad source i. In the presence of more than two ad sources, the same rule applies with several nested loops for all ad sources, which is further described below in FIG. 13. The decision making is performed in real time and based on a computed threshold value rule, thus allowing the decision module to make real time decisions quickly based on simple rules. The process is automatic, self-driving and can run on any ad network without human intervention.

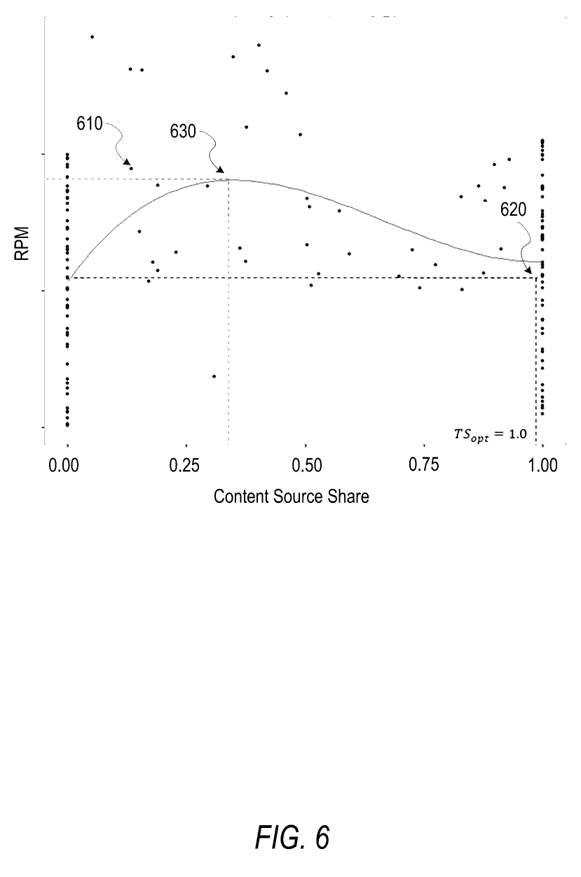

In various embodiments, the optimization module 350 uses several data model fitting to determine the threshold value, as illustrated in FIGS. 5-7. The degree of polynomial model fitting may vary depending on the data, including cubic, quatric, or linear model fitting. Where the data contains a local maxima and a minima point, then a cubic polynomial model is used for the data points, as illustrated in FIG. 5. In various embodiments, the model is constrained to have a maximum of a cubic degree polynomial fitting in order to prevent multiple local maxima or minima and therefore avid over fitting of the data. Where the data has either of a maxima or a minima, then a quadratic polynomial model is used for the data points, as illustrated in FIG.6. In other embodiments, where the data model has a linear trend, then a linear polynomial is used for the data points.

FIG. 5 illustrates a rule based polynomial model fitting for traffic allocation between two content sources with the objective of maximizing RPM, according to some example embodiments. Each data point, represented by 510 is obtained from the data module 330, and a polynomial model is fitted to the data. As shown in FIG. 5, the data model contains a maxima and a minima point which results in a cubic polynomial model fitting. The model rule may be constrained to a maximum of a cubic degree model in order to prevent multiple maxima and minima and as a result avoid over fitting of the data. In an example, FIG. 5 shows a model fitting to existing data in order to compute the threshold with the objective of maximizing RPM. The x-axis on the right border of the plot has 100% j traffic share (i.e., 100% traffic share allocated to source j). The x-axis on the left border of the plot has 100% i traffic share (i.e., 100% traffic share allocated to source i and 0% j traffic share). In this illustration, ad source j is ECN traffic share and ad source i is Google traffic share. The region in the middle represents a mixture of the traffic shares on the x-axis with its corresponding RPM on the y-axis. In this example, the resulting threshold value, λᵢⱼ, determined by the optimization module 350 with the objective of maximizing RPM is at the maxima point 520 of the model, at TSₒₚₜ=0.77.

FIG. 6 shows a polynomial model fitting to existing data in order to compute the threshold with the objective of maximizing traffic share for a specific content source, such an in-house ad source ECN. The polynomial model fitting is for traffic allocation between two content sources (e.g., ECN ad source and Google ad source), shown in the x-axis of content source share. Each data point, represented by 610 is obtained from the data module 330. The data model that contains a single maxima (or a single minima) point results in a quadratic polynomial fitting to the data. The right border of the plot has 100% j traffic share, i.e. 100% traffic share allocated to source j, where source j is ECN ad source in this example. The left border of the plot has % i traffic share, i.e. 100% traffic share allocated to source i, where source i is Google ad source in this example. The region in the middle represented a mixture of the traffic shares on the x-axis with its corresponding RPM on the y-axis. In this example, although the ECN traffic share corresponding to the maximum RPM is at the maxima point 630, at about 0.3, according to the objective of maximizing in-house traffic share with an acceptable loss in RPM (determined by a loss threshold value), a higher ECN traffic share that is at least as good as ad source i is chosen as threshold value. The resulting threshold value, λᵢⱼ, determined by the optimization module 350 with the objective of maximizing in-house traffic share (where the in-house traffic share is at least as good as the Google traffic share, which is at point 620 of the model, at 1.0.

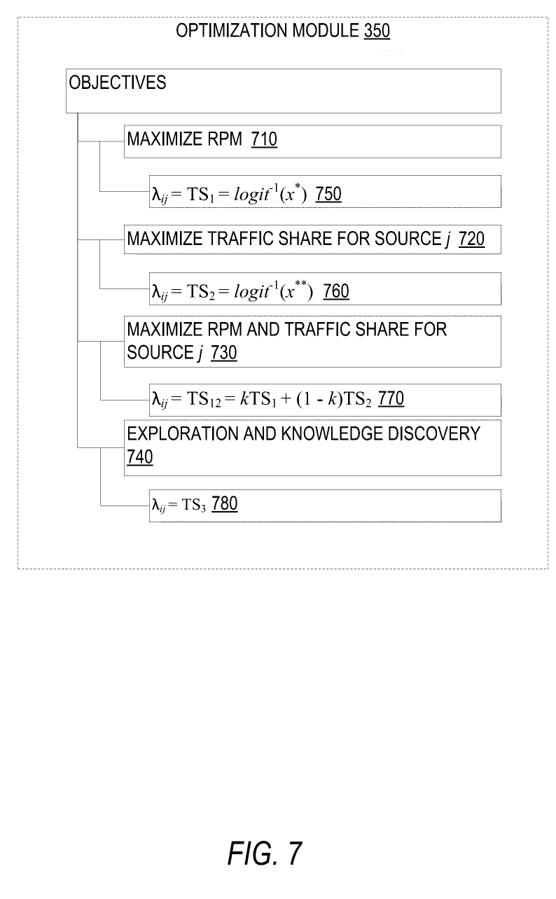

In various embodiments, FIG. 7 illustrates three main objectives that the optimization module 350 may implement, objective 710 which maximizes RPM, objective 720 which maximizes traffic share for source j, and knowledge discovery objective 740. The system can implement the objectives individually or combined, such as objective 730, combining both objective 710 and 720 to maximize RPM while maximizing for traffic share for source j. The objectives utilize polynomial fitting using a linear regression approach with the predictor variable being traffic share source j. As an example, the traffic share source j can be the ECN traffic share and the response variable is the RPM, denoted by y. A logit transformation can be used on the predictor variable, i.e. ECN traffic share, to determine the threshold value for each corresponding objective.

In a specific example, applying the logit transformation results in the transformed variable denoted by x as follows:

$$x = log \frac{ECN traffic share}{1 - ECN traffic share}$$

The ECN traffic share can be subsequently calculated using the logit transformation as follows:

$$ECN traffic share = \frac{{e}^{x}}{{e}^{x} + 1}$$

In a specific example, the fitted polynomial is represented by the equation as follows:

y=f(x)=ax³+bx²+cx+d

In this equation, coefficients a, b, c, and d depends on the data observed. When the optimization module 350 implements objective 710, which is the objective of maximizing RPM, the optimal data point, corresponding to the maximum point on the polynomial is calculated using x* as follows:

$${x}^{*} = {arg}_{x ∈ \{ {x}^{-} , {x}^{+} \}} {f}^{″} ( x ) < 0 , \\ where$$

$${f}^{″} ( x ) = \frac{{d}^{2} y}{d {x}^{2}} = 6 ax = 2 b .$$

In a specific example, the derivative of the fitted polynomial function is taken to yield:

$$\frac{d y}{d x} = {f}^{′} ( x ) = 3 {ax}^{2} + 2 bx + c$$

In this equation, the roots x⁻ and x⁺ can be determined by setting

$$\frac{d y}{d x} = 0$$

to determine the optimal point as follows:

$${x}^{-} = \frac{- b - \sqrt{{b}^{2} - 3 ac}}{3 a}$$

$$and$$

$${x}^{+} = \frac{- b + \sqrt{{b}^{2} - 3 ac}}{3 a}$$

The resulting threshold value 750, λᵢⱼ, with the objective of maximizing RPM 710 is as follows:

λᵢⱼ=TS₁=logit⁻¹(x*)

In this equation, i can be represented by any traffic ad source such as Google, and j is represented by any other traffic ad source such as ECN. When improving maximal traffic share for source j, while accounting for an acceptable loss in RPM such that the RMP yield for the resulting threshold value would be on par with Google traffic share.

In a specific example, the polynomial equation y_{G}=ax³+bx²+cx+d is used to determine the threshold value. In this equation, y_{G} is the expected RMP for Google traffic share with maximum real roots of the equation y_{G} denoted by x**. The resulting threshold value 760, λᵢⱼ, when improving maximal ECN traffic share 720 is as follows:

λᵢⱼ=TS₂=logit⁻¹(x**)

In a specific example, such as shown in 730, where the objective is both maximizing RPM along with maximizing ECN traffic share, the resulting threshold value 770 is as follows: λᵢⱼ=TS₃=logit⁻¹(x*): λᵢⱼ=TS₂=logit⁻¹(x**)λᵢⱼ=TS₁₂=kTS₁+(1−k)TS₂

TS₁₂=kTS₁+(1−k)TS₂

In various embodiments, the objective of exploring traffic share regions having little or no data information is knowledge discovery 780. In obtaining the threshold value for knowledge discovery objective, the traffic share range of (0,1) is divided into five equal segments resulting in segments 0.0-0.2, 0.2-0.4, 0.4-0.6, 0.6-0.8, 0.8-1.0. The sum of the weight of the data points in each segments is then computed. The segment with the highest sum corresponds to the most relevant data point with consideration of the weight associated with each data point. A probability inversely proportional to this sum is assigned to each segment. The resulting segment with the highest probability is associated with having the least data point.

In a specific example, the probability for segment selection is determined as follows:

$$Pr ( s \text{\textbar} data ) = \frac{1 / {\sum }_{z ∈ s} {w}_{z}}{{\sum }_{{s}^{′} ∈} s ( 1 / {\sum }_{z ∈ s} {w}_{z} )}$$

In this example, the segments are denoted by S ∈ {1, 2, 3, 4, 5}. A segment is randomly selected based on the probabilities from the resulting segments and a traffic share point threshold TS₃ is randomly selected within that segment. After randomly selecting a segment based on the probability, s*, the random traffic share point based on the probability is TS₃ ∈ s*. The resulting threshold 780 is TS₃ used for further exploration for model learning.

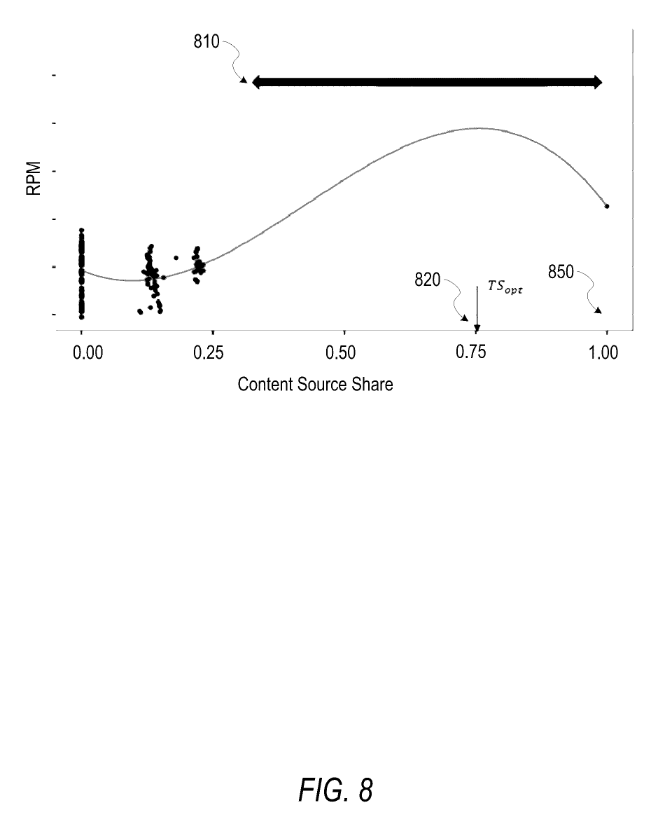

In various embodiments, the optimization module 350 is configured to explore traffic share regions having little or no data information by allocating a portion of the content source share to the ad source with little or no data information. As an example, FIG. 8 shows no data for the content source share k, 850, on the right side region 810, resulting in a bad model fitting. The x-axis labels of content source share between two ad source is the same as illustrated in FIG. 5 and FIG. 6, such that the right boarder represents a first ad source (e.g. ECN ad source), while the left boarder represents a second ad source (e.g., Google ad source). A low confidence, shown by a large standard error at traffic share 820 at 0.75, along with little or no data on the right side of the graphic indicates that the traffic share region is not explored, and therefore a portion of the traffic share for ad source allocation is assigned to that region to garner knowledge of the output objective such as maximizing RPM or maximizing in-house ad source traffic share. As a result, the threshold value is at 0.75 in order to assign a traffic share in that region to collect more information.

In various embodiments, data points obtained from the data module 330, such as data point 510 and 610, are each assigned a weight. The size of the data point dot on the scatter plots illustrated in FIG. 5 and FIG. 6 denotes the data point weight, with a larger dot having a larger weight associated with the data point. Data points that were observed more recently in time is assigned a larger weight relative to data points that were obtained at an earlier date. As an example, the data observed today is assigned a larger weight than data that are two weeks old.

FIG. 9 illustrates the dependent relationship of the weights of the data points to the time the data points were observed relative to the current day. The data module 330 determines the weight of the data for the optimization module 350 to determine the best fit polynomial model. As shown in FIG. 9, the x-axis (represented by d) represents the number of days the data is away from the current day and the y-axis (represented by w_{z}) is the corresponding weight based on an exponential function with parameter γ. In a specific example, the exponential weight distribution with a small γ, such as 0.01 has a near linear decreased day away from current day increases, represented by 610. A larger γ, such as 0.1 decreases much more rapidly reaching close to a weight of 0 after the data is about one-month old, represented by 920. The parameter γ allows for flexibility to change the effect of the data points on the polynomial fitting when improving and optimizing for RPM or in-house ad source traffic share.

In a specific example, the graph shown in FIG. 9 is represented by the function as follows:

w_{z}=e^{γd}

In this equation, w_{z} is the weight for the data point z, and data point z is d days away from the current day.

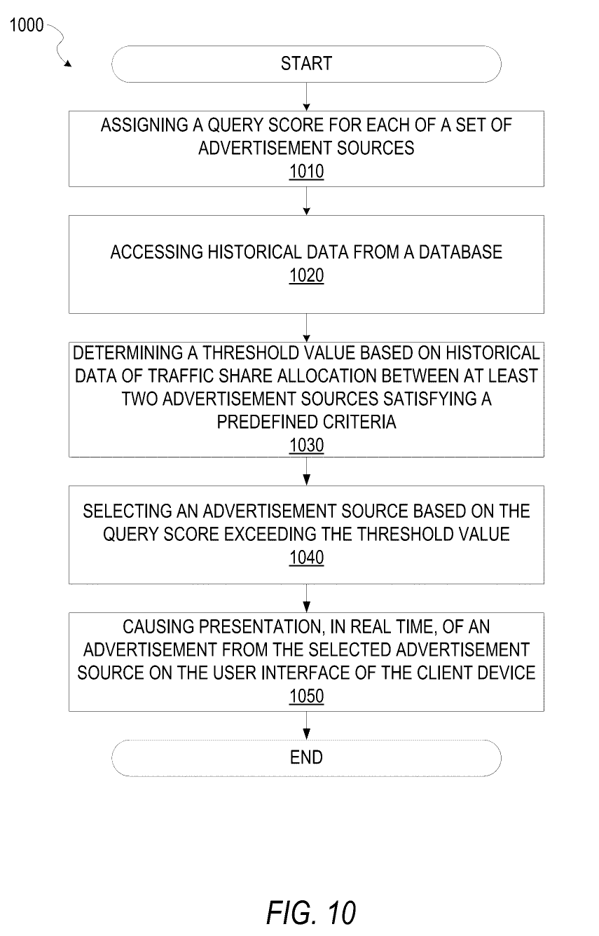

FIG. 10 is a flow diagram that illustrates an example method 1000 for managing the allocation of traffic share in the presence of multiple ad source. The operations of method 1000 can be performed by components of the content source regulation system 150, and are so described below for the purpose of illustration.

At operation 1010, the scoring module 340 receives a query from a user interface at the client device 110 and assigns a query score for each of a set of advertisement sources. The scoring module 340 assigns a score for each data ad source available to serve the search query. The score is determined based on whether the advertising information stored within the ad source is relevant (e.g., the compared information matching in whole or at least in part) to the query content or the search query condition. A score is assigned for each ad source available to serve the query.

At operation 1020, the optimization module 350 accesses historical data directly from a database or from the data module 330. The historical data include information how well traffic shares from specific sources functions to serve specific types of query from the user. For instance, the information includes how well certain portions of ECN traffic share performs regarding RPM or CTR.

At operation 1030, the optimization module 350 determines a threshold value based on the historical data of traffic share allocation between at least two advertisement sources satisfying a predefined criteria. This predefined criteria is the different objectives in computing the threshold value, which is improved in light of the predefined criteria. These various objectives include maximizing revenue per mille (RPM), maximizing traffic share for a specific source, such as in-house ad source, or knowledge discovery and exploration. When maximizing RPM, the objective is to determine the traffic share allocation that results in the maximum RPM or a predefined target RPM. When maximizing traffic share for a specific source, the objective is to determine the the traffic share allocation that results in the maximum traffic shares for a desired source with an acceptable loss in RPM (determined by a loss threshold value). In other embodiments, the objective of the threshold value can include both objective of maximizing RPM and maximizing traffic share for a specific ad source.

At operation 1040, the decision module 360 compares the query score determined by the scoring module 340 with the threshold value determined by the optimization module 350. When compared, if the query score is higher than the threshold value, then ad source i is chosen to serve the query, where ad source i is the ad source with a less percentage share allocation when compared with ad source j. FIG. 5 is a graph that illustrates a polynomical model fitting with the objective of maximizing RMP. The threshold is determined to be 0.77. In this example, if the query score is determined to be 0.8, then ad source i is chosen to serve the query. If the query score is lower than the threshold value, then ad source j is chosen to serve the query, where ad source is the ad source with a higher percentage share allocation when compared with ad source i. Referring to FIG. 5 again, in this example, if the query score is determined to be 0.5, the query score is less than the threshold 0.77, and therefore ad source j is chosen to serve the query. The x-axis on the right border of the plot has 100% j traffic share, i.e. 100% traffic share allocated to source j. The x-axis on the left border of the plot has 100% i traffic share, i.e. 100% traffic share allocated to source i and 0% j traffic share.

At operation 1050, the presentation module 360 causes presentation, in real-time, of an advertisement from the selected advertisement source on the user interface of the client device from operation 1040.

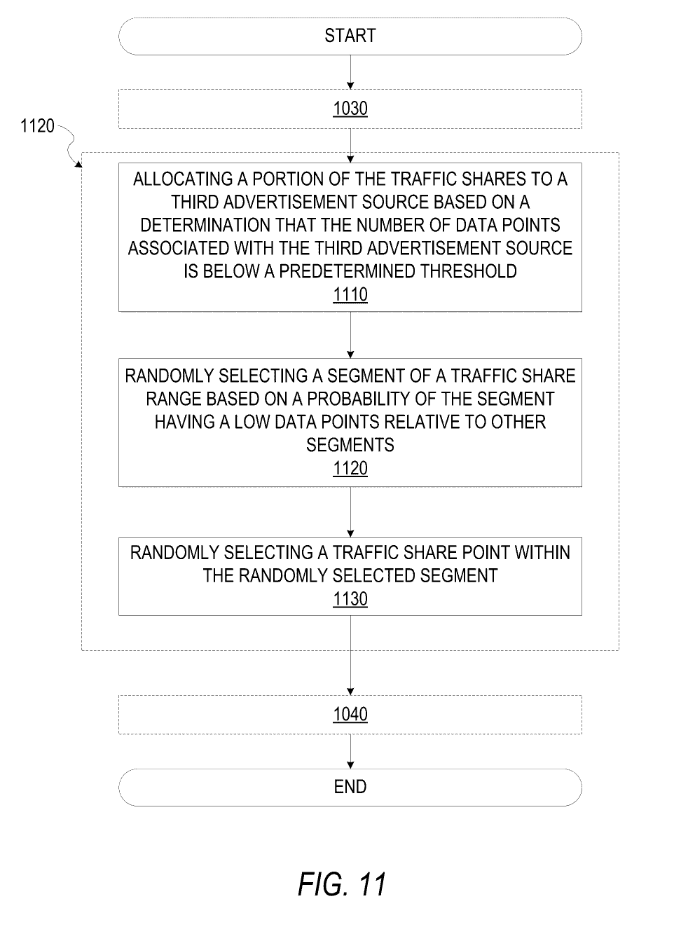

FIG. 11 is a flow diagram that illustrates an example method 1100 for managing the allocation of traffic share in the presence of multiple advertisement source with the objective of knowledge discovery and exploration. The operations of method 1100 can be performed by components of the content source regulation system 150, and are so described below for the purpose of illustration.

At operation 1110, the optimization module 350 allocates a portion of the traffic shares to a third advertisement source based on a determination that the number of data points associated with the third advertisement source is below a predetermined threshold. The purpose of allocating a portion of the traffic shares is to explore traffic share regions having little or no data information. The predetermined threshold can be based on determining that there is a large standard error at a specific region of the model fit. In a specific example, FIG. 8 illustrates a low confidence (e.g., large standard error at traffic share 820 at 0.75) in the model fit due to little or no data on the right side of the graph. Based on the low confidence in the model fit, a portion of the traffic share is assigned to that region to garner knowledge of the output objective such as maximizing RPM or maximizing in-house ad source traffic share. This information resulting from the knowledge discovery is then fed back to the database in real-time in order for the optimization module 350 to more accurately determine the threshold value for comparison with the query score.

In various embodiments, at operation 1120, for exploration and knowledge discovery, the optimization module 350 randomly selects a segment of a traffic share range based on a probability of the segment having low data points relative to other segments. The traffic share range of (0,1) is divided into equal segments, where the sum of the weight of the data points in each segments are then computed. For each equally divided segment, the segment with the highest sum of weights corresponds to the most relevant data point. A probability inversely proportional to this sum is assigned to each segment. The resulting segment with the highest probability is associated with having the least data point and thus chosen for exploration and knowledge discovery. Within the segment having the least data point, a traffic share point is randomly selected for traffic share allocation at operation 1130.

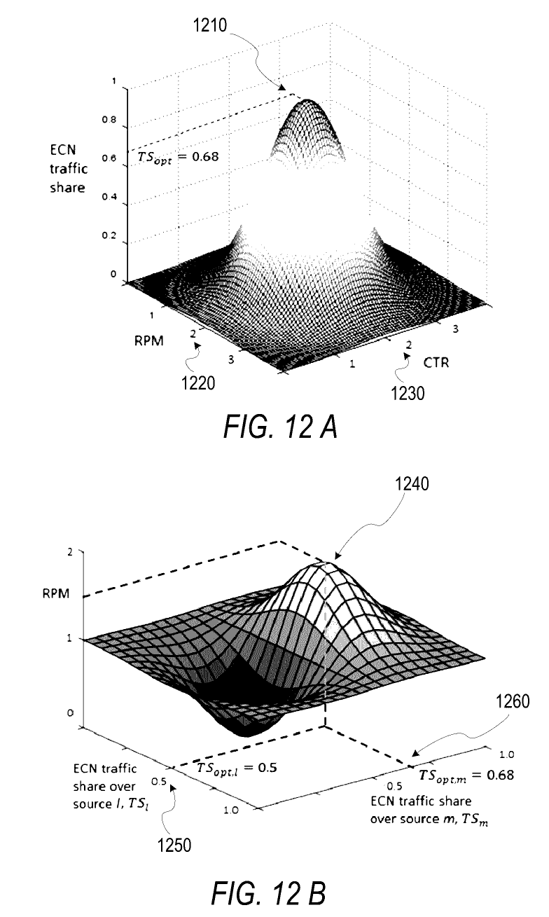

In various embodiments, the content source regulation system is extended to multi-dimensional optimization, including maximizing traffic share assignment involving more than one performance metric and maximizing traffic share assignment in the presence of more than two ad sources. The optimization module 350 can be configured to determine the improved traffic share with the objective of maximizing multiple performance metrics. As an example, the objective can be to maximize RPM and CTR (click-through rate), where the CTR is the number of times a click is made on the advertisement divided by the total impressions (the number of times an advertisement was served), expressed as a percentage. As an example, FIG. 12A illustrates maximizing multiple performance metrics which requires multi-dimensional model fitting. The multi-dimensional model illustrates the distribution found from fitting the observed RPM and CTR for different traffic shares. In this specific example, RPM is plotted on the x-axis, CTR is plotted on the y-axis, and ECN traffic share is plotted on the z-axis. When maximizing for both RPM and CTR, the threshold output from the optimization module 350 is determined at the peak 1210 of distribution model at TSopt=0.68, which is 68% ECN traffic share. The peak 1210 corresponds to where the combination of a maximized RPM 1120 and maximized CTR 1230 would result in the maximal ECN traffic share.

In various embodiments, multi-dimensional optimization is extended to maximizing traffic share assignment in the presence of more than two ad sources. As an example, the optimization module 350 can be configured to maximize only one performance metric, RPM, with K ad sources, where K is the number of ad sources. FIG. 12B illustrates maximizing the performance metric RPM in the presence of three ad sources, K=3, including in-house ECN ad source, ad source l, and ad source m. In this example, the x-axis is the traffic share ratio of ECN traffic share to ad source l traffic share, denoted by TSₗ. This approach is similar to the one-dimensional model fitting as shown in FIG. 5 for two ad sources j and i, where j and i are respectively ECN and ad source l. The y-axis is the traffic share ratio of ECN traffic share to ad source m, denoted by TSₘ. The z-axis is the optimization performance metric RPM. Using a multi-dimensional fit distribution, the traffic shares TSₗ and TSₘ with the corresponding peak 1240 (maximum RPM) of the fit distribution is denoted by TS_{opt,l}=0.5 (1250) and TS_{opt,m}=0.68 (1260). At 1250, the traffic share between ECN ad source and ad source 1 is maximized on the x-axis in the three-dimensional model fit. At 1260, the traffic share between ECN ad source and ad source m is maximized on the y-axis in the three-dimensional model fit.

Each of these improved traffic shares while maximizing for RPM will respectively yield thresholds, λₗ and λₘ. The peak 1240 corresponds to the traffic share allocation between three ad source, ECN, ad source j, ad source i would result in a maximized RPM.

In various embodiments, in multi-dimensional optimization, when a user submits a query, the query is scored and the query score is compared with each threshold in a stepwise comparison. The stepwise score comparison is retrieved from the score comparison rule from the data module 330. In the example shown in FIG. 12B, each ad source are ranked according to their average RPM in decreasing order. Given that RPMₗ>RPMₘ, the query score is first compared with λₗ, and if the query score <λₗ, then the ad source l is assigned to serve the query. However, if query score is >λₗ, then the system proceeds with the comparison with λₘ. If the query score <λₘ, then the ad source m is assigned to serve the query, otherwise, the system proceeds with the assigning the in-house ECN ad source to serve the query.

In various embodiments, FIG. 13 illustrates a stepwise comparison occurring between the query score and each ad source threshold. The stepwise comparison continues for as many ad sources there are available to compare the query score, where the ad sources are arranged in decreasing order of their average RPM in the order of the comparison with the highest average RPM yielding ad source being compared first (e.g. ad source K₁), and the lowest average RPM yielding ad source being compared last (e.g. ad source Kₙ₋₁). The default base if no ad source threshold is larger than the query score is assigning the in-house source 1395 to serve the query. In an example, a query score 1310 is compared to λ₁, where λ₁ is the traffic share allocation threshold between the in-house ad source and ad source K₁. If the query score 1310 is less than λ₁, then ad source K₁ 1330 is assigned to serve the query. However, if the query score 1310 is greater than λ₁, then the system proceeds with comparing the query score 1310 to λ₂, where λ₂ is the traffic share allocation threshold between the in-house ad source and ad source K₂. If the query score 1310 is less than λ₂, then ad source K₂ 1350 is assigned to serve the query. However, if the query score 1310 is greater than λ₂, then the system proceeds with comparing the query score 1310 to λ₃. If the query score 1310 is less than λ₃, then ad source K₃ 1370 is assigned to serve the query, else the system proceeds down the arranged ad sources to ad source Kₙ₋₁, the ad source with the lowest average RPM yield. If the query score 1310 is less than λₙ₋₁, then ad source Kₙ₋₁ 1390 is assigned to serve the query. However, if the query score 1310 is greater than λₙ₋₁, then the system assigns the in-house ad source 1395 to serve the query.

### Modules, Components, and Logic

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Software Architecture

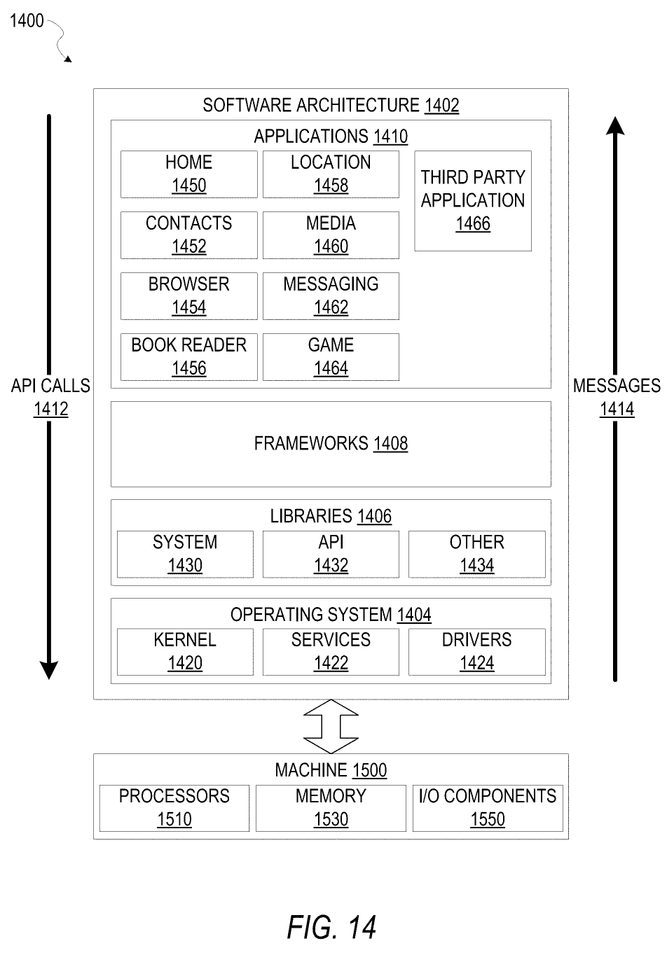

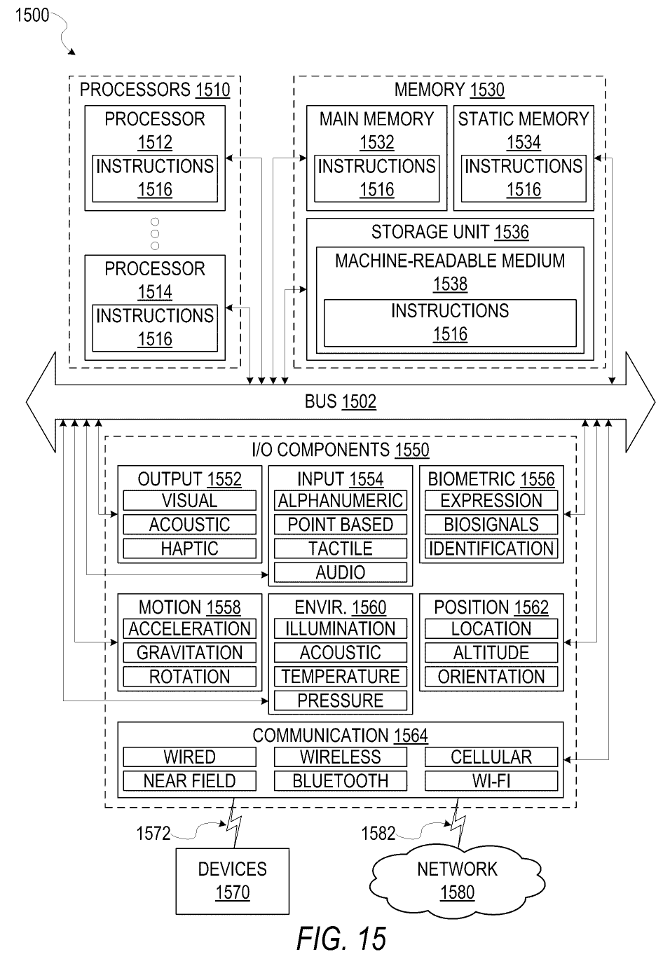

FIG. 14 is a block diagram 1400 illustrating an architecture of software 1402, which may be installed on any one or more of the devices described above. FIG. 14 is merely a non-limiting example of a software architecture, and it will be appreciated that many other architectures may be implemented to facilitate the functionality described herein. The software 1402 may be implemented by hardware such as machine 1500 of FIG. 15 that includes processors 1510, memory 1530, and I/O components 1550. In this example architecture, the software 1402 may be conceptualized as a stack of layers where each layer may provide a particular functionality. For example, the software 1402 includes layers such as an operating system 1404, libraries 1406, frameworks 1408, and applications 1410. Operationally, the applications 1410 invoke application programming interface (API) calls 1412 through the software stack and receive messages 1414 in response to the API calls 1412, according to some implementations.

In various implementations, the operating system 1404 manages hardware resources and provides common services. The operating system 1404 includes, for example, a kernel 1420, services 1422, and drivers 1424. The kernel 1420 acts as an abstraction layer between the hardware and the other software layers in some implementations. For example, the kernel 1420 provides memory management, processor management (e.g., scheduling), component management, networking, security settings, among other functionality. The services 1422 may provide other common services for the other software layers. The drivers 1424 may be responsible for controlling or interfacing with the underlying hardware. For instance, the drivers 1424 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1406 provide a low-level common infrastructure that may be utilized by the applications 1410. The libraries 1406 may include system 1430 libraries (e.g., C standard library) that may provide functions such as memory allocation functions, string manipulation functions, mathematic functions, and the like. In addition, the libraries 1406 may include API libraries 1432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1406 may also include a wide variety of other libraries 1434 to provide many other APIs to the applications 1410.

The frameworks 1408 provide a high-level common infrastructure that may be utilized by the applications 1410, according to some implementations. For example, the frameworks 1408 provide various graphic user interface (GUI) functions, high-level resource management, high-level location services, and so forth. The frameworks 1408 may provide a broad spectrum of other APIs that may be utilized by the applications 1410, some of which may be specific to a particular operating system or platform.

In an example embodiment, the applications 1410 include a home application 1450, a contacts application 1452, a browser application 1454, a book reader application 1456, a location application 1458, a media application 1460, a messaging application 1462, a game application 1464, and a broad assortment of other applications such as third party application 1466. According to some embodiments, the applications 1410 are programs that execute functions defined in the programs. Various programming languages may be employed to create one or more of the applications 1410, structured in a variety of manners, such as object-orientated programming languages (e.g., Objective-C, Java, or C++) or procedural programming languages (e.g., C or assembly language). In a specific example, the third party application 1466 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1466 may invoke the API calls 1412 provided by the mobile operating system 1404 to facilitate functionality described herein.

### Example Machine Architecture and Machine-Readable Medium

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1516, sequentially or otherwise, that specify actions to be taken by machine 1500. Further, while only a single machine 1500 is illustrated, the term “machine” shall also be taken to include a collection of machines 1500 that individually or jointly execute the instructions 1516 to perform any one or more of the methodologies discussed herein. In an example embodiment, machine 1500 is an application server that comprises of the content source regulation system 150. The processors 1512 and 1514 implements the modules 310-360 of the content source regulation system 150 and execute the instructions in order to determine the appropriate ad source to serve an input query from a user device connected to the network 1580 or the internet.

The machine 1500 may include processors 1510, memory 1530, and I/O components 1550, which may be configured to communicate with each other via a bus 1502. In an example embodiment, the processors 1510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1512 and processor 1514 that may execute instructions 1516. The term “processor” is intended to include multi-core processors that may comprise two or more independent processors (also referred to as “cores”) that may execute instructions contemporaneously. Although FIG. 15 shows multiple processors, the machine 1500 may include a single processor with a single core, a single processor with multiple cores (e.g., a multi-core process), multiple processors with a single core, multiple processors with multiples cores, or any combination thereof.

The memory 1530 may include a main memory 1532, a static memory 1534, and a storage unit 1536 accessible to the processors 1510 via the bus 1502. The storage unit 1536 may include a machine-readable medium 1538 on which is stored the instructions 1516 embodying any one or more of the methodologies or functions described herein. The instructions 1516 may also reside, completely or at least partially, within the main memory 1532, within the static memory 1534, within at least one of the processors 1510 (e.g., within the processor's cache memory), or any suitable combination thereof, during execution thereof by the machine 1500. Accordingly, in various implementations, the main memory 1532, static memory 1534, and the processors 1510 are considered as machine-readable media 1538.

As used herein, the term “memory” refers to a machine-readable medium 1538 able to store data temporarily or permanently and may be taken to include, but not be limited to, random-access memory (RAM), read-only memory (ROM), buffer memory, flash memory, and cache memory. While the machine-readable medium 1538 is shown in an example embodiment to be a single medium, the term “machine-readable medium” should be taken to include a single medium or multiple media (e.g., a centralized or distributed database, or associated caches and servers) able to store instructions 1516. The term “machine-readable medium” shall also be taken to include any medium, or combination of multiple media, that is capable of storing instructions (e.g., instructions 1516) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1550 include a wide variety of components to receive input, provide output, produce output, transmit information, exchange information, capture measurements, and so on. In general, it will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 include output components 1552 and input components 1554. The output components 1552 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1554 include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In some further example embodiments, the I/O components 1550 include biometric components 1556, motion components 1558, environmental components 1560, or position components 1562 among a wide array of other components. For example, the biometric components 1556 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1558 include acceleration sensor components (e.g., accelerometer), gravitation sensor components, rotation sensor components (e.g., gyroscope), and so forth. The environmental components 1560 include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detection concentrations of hazardous gases for safety or to measure pollutants in the atmosphere), or other components that may provide indications, measurements, or signals corresponding to a surrounding physical environment. The position components 1562 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 or devices 1570 via coupling 1582 and coupling 1572, respectively. For example, the communication components 1564 include a network interface component or another suitable device to interface with the network 1580. In further examples, communication components 1564 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1570 may be another machine or any of a wide variety of peripheral devices (e.g., a peripheral device coupled via a Universal Serial Bus (USB)).

Moreover, in some implementations, the communication components 1564 detect identifiers or include components operable to detect identifiers. For example, the communication components 1564 include Radio Frequency Identification (RFID) tag reader components, NFC smart tag detection components, optical reader components (e.g., an optical sensor to detect a one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1564, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or other type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

In example embodiments, the instructions 1516 are transmitted or received over the network 1580 using a transmission medium via a network interface device (e.g., a network interface component included in the communication components 1564) and utilizing any one of a number of well-known transfer protocols (e.g., Hypertext Transfer Protocol (HTTP)). Similarly, in other example embodiments, the instructions 1516 are transmitted or received using a transmission medium via the coupling 1572 (e.g., a peer-to-peer coupling) to devices 1570. The term “transmission medium” shall be taken to include any intangible medium that is capable of storing, encoding, or carrying instructions 1516 for execution by the machine 1500, and includes digital or analog communications signals or other intangible medium to facilitate communication of such software.

Furthermore, the machine-readable medium 1538 is non-transitory (in other words, not having any transitory signals) in that it does not embody a propagating signal. However, labeling the machine-readable medium 1538 as “non-transitory” should not be construed to mean that the medium is incapable of movement; the medium should be considered as being transportable from one physical location to another. Additionally, since the machine-readable medium 1538 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a scoring module, implemented by at least one hardware processor of a machine, configured to, in response to a query submitted by a user at a user interface, assign a query score for each of a set of advertisement sources;
a optimization module configured to determine a threshold value based on historical data of traffic share allocation between at least two advertisement sources satisfying a predefined criteria, the historical data accessed from a database;
a decision module configured to select an advertisement source from the set of advertisement sources based on the query score for the advertisement source exceeding the threshold value; and
a presentation module configured to cause presentation, in real time, of an advertisement from the selected advertisement source on the user interface of a client device.

2. The system of claim 1, wherein the predefined criteria includes an optimal revenue measurement threshold or an optimal advertisement traffic share allocated to a selected source.

3. The system of claim 2, wherein the optimization module is further configured to allocate a portion of the traffic shares to a third advertisement source based on a determination that the number of data points associated with the third advertisement source is below a predetermined threshold.

4. The system of claim 3, wherein the allocating a portion of the traffic share to a third advertisement source is triggered by a confidence score failing to transgress a predetermined threshold, the confidence score based on a standard error of a model fitting.

5. The system of claim 4, wherein the historical data include information about the traffic share allocated to the third advertisement source.

6. The system of claim 1, wherein the historical data is weighted according to the number of days that have past relative to the day of the historical data accumulation.

7. The system of claim 1, wherein the optimization module is further configured to:
randomly select a segment of a traffic share range based on a probability of the segment having a low number of data points relative to other segments; and
randomly select a traffic share point within the randomly selected segment.

8. A method comprising:
assigning, using at least one hardware processor of a machine and in response to a query submitted by a user at a user interface of a client device, a query score for each of a set of advertisement sources;
accessing historical data from a database;
determining a threshold value based on historical data of traffic share allocation between at least two advertisement sources satisfying a predefined criteria;
selecting an advertisement source from the set of advertisement sources based on the query score for the advertisement source exceeding the threshold value; and
causing presentation, in real time, of an advertisement from the selected advertisement source on the user interface of a client device.

9. The method of claim 8, wherein the predefined criteria includes an optimal revenue measurement threshold or an optimal advertisement traffic share allocated to a selected source.

10. The method of claim 9, further comprising allocating a portion of the traffic shares to a third advertisement source based on a determination that the number of data points associated with the third advertisement source is below a predetermined threshold.

11. The method of claim 10, wherein the allocating a portion of the traffic share to a third advertisement source is triggered by a confidence score failing to transgress a predetermined threshold, the confidence score based on a standard error of a model fitting.

12. The method of claim 11, wherein the historical data include information about the traffic share allocated to the third advertisement source.

13. The method of claim 8, wherein the historical data is weighted according to the number of days that have past relative to the day of the historical data accumulation.

14. The method of claim 8, further comprising:
randomly selecting a segment of a traffic share range based on a probability of the segment having a low number of data points relative to other segments; and
randomly selecting a traffic share point within the randomly selected segment.

15. A machine-readable medium having no transitory signals and storing instructions that, when executed by at least one processor of a machine, cause the machine to perform operations comprising:
assigning, using at least one hardware processor of a machine and in response to a query submitted by a user at a user interface of a client device, a query score for each of a set of advertisement sources;
accessing historical data from a database;
determining a threshold value based on historical data of traffic share allocation between at least two advertisement sources satisfying a predefined criteria;
selecting an advertisement source from the set of advertisement sources based on the query score for the advertisement source exceeding the threshold value; and
causing presentation, in real time, of an advertisement from the selected advertisement source on the user interface of a client device.

16. The machine-readable medium of claim 15, wherein the predefined criteria includes an optimal revenue measurement threshold or an optimal advertisement traffic share allocated to a selected source.

17. The machine-readable medium of claim 16, further comprising allocating a portion of the traffic shares to a third advertisement source based on a determination that the number of data points associated with the third advertisement source is below a predetermined threshold.

18. The machine-readable medium of claim 17, wherein the allocating a portion of the traffic share to a third advertisement source is triggered by a confidence score failing to transgress a predetermined threshold, the confidence score based on a standard error of a model fitting

19. The machine-readable medium of claim 18, wherein the historical data include information about the traffic share allocated to the third advertisement source.

20. The machine-readable medium of claim 15, further comprising:
randomly selecting a segment of a traffic share range based on a probability of the segment having a low number of data points relative to other segments; and
randomly selecting a traffic share point within the randomly selected segment.
